(19) United States
(12) Patent Application Publication
(10) Pub. No.: US 2026/0301670 A1
(43) Pub. Date: Oct. 1, 2026

(54) DISPLAY PANEL AND DISPLAY APPARATUS

(71) Applicant: Tianma Advanced Display Technology Institute (Xiamen) Co., Ltd., Xiamen (CN)

(72) Inventors: Yingteng ZHAI, Xiamen (CN); Wang Chen, Xiamen (CN)

(73) Assignee: Tianma Advanced Display Technology Institute (Xiamen) Co., Ltd., Xiamen (CN)

(21) Appl. No.: 19/268,984

(22) Filed: Jul. 14, 2025

(30) Foreign Application Priority Data
Mar. 28, 2025 (CN) 202510386163.6

(51) Int. Cl. G09G 3/3233; G09G 3/20; G09G 3/3266

(52) U.S. Cl. CPC G09G 3/3233; G09G 3/2011; G09G 3/2014; G09G 3/3266; G09G 2300/0819; G09G 2300/0852; G09G 2300/0861; G09G 2310/0286; G09G 2310/08; G09G 2320/0233

(57) ABSTRACT

Embodiments of the present application provide a display panel and a display apparatus. The display panel comprises: R pixel circuit rows; a first scanning driving circuit configured to scan one row of pixel circuits for a duration of t; a first light-emitting driving circuit, the first light-emitting driving circuit provides a first light-emitting control signal including S first sub-segments for the pixel circuit rows; wherein the pixel circuit comprises a first data writing transistor, the first electrode of the first data writing transistor is electrically connected to the data line, and the control end of the first data writing transistor is electrically connected to the first scanning driving line, and the first scanning driving circuit is electrically connected to the first scanning driving line; wherein the one-frame scanning time T of the display panel comprises a display scanning period and a front-and-back porch period.

### CROSS-REFERENCE TO RELATED APPLICATIONS

This application claims priority to Chinese Patent Application No. 202510386163.6, titled “DISPLAY PANEL AND DISPLAY APPARATUS” and filed on Mar. 28, 2025, which is hereby incorporated by reference in its entirety.

### TECHNICAL FIELD

The present application relates to the technical field of displays, and particularly to a display panel and a display apparatus.

### BACKGROUND

With the development of the information society, the demand for display panels for displaying images has been increasing. Examples of such display panels include micro LEDs (Micro Light Emitting Diodes), OLEDs (Organic Light Emitting Diodes), etc.

However, as the display technology continues to develop, user requirements for performance of the display panels are gradually increasing. Therefore, how to optimize the performance of display panels is an important issue faced by those skilled in the art.

### SUMMARY

Embodiments of the present application provide a display panel and a display apparatus, which can optimize the performance of the display panel.

In the first aspect, an embodiment of the present application provides a display panel, which comprises: pixel circuits, a plurality of the pixel circuits being arranged in a first direction to form pixel circuit rows, R pixel circuit rows being arranged in a second direction, the first direction intersects with the second direction; a first scanning driving circuit, the first scanning driving circuit provides a first scanning driving signal for the pixel circuit rows, a duration of the first scanning driving circuit scanning one row of pixel circuits is t; and a first light-emitting driving circuit, the first light-emitting driving circuit provides a first light-emitting control signal including S first sub-segments to the pixel circuit rows, a duration of the first sub-segment is m*t, where m is a positive integer, wherein the pixel circuit comprises a first data writing transistor, a first electrode of the first data writing transistor is electrically connected to a data line, and a control terminal of the first data writing transistor is electrically connected to a first scanning driving line, the first scanning driving circuit is electrically connected to the first scanning driving line, wherein an one-frame scanning time T of the display panel includes a display scanning period and a front-and-back porch period, a duration of the display scanning period is M, and a duration of the front-and-back porch period is N, where M=R*t, N=P*t, T=M+N, wherein S=(R+P)/m, S is a positive integer, and R/m is a positive integer.

In the second aspect, an embodiment of the present application provides a display apparatus, which comprises a display panel comprising: R pixel circuit rows being arranged in a second direction, a plurality of pixel circuits being arranged in a first direction to form the pixel circuit row, the first direction intersecting with the second direction; a first scanning driving circuit, the first scanning driving circuit providing a first scanning driving signal for the pixel circuit row, a duration of the first scanning driving circuit scanning a row of the pixel circuits being t; and a first light-emitting driving circuit, the first light-emitting driving circuit providing a first light-emitting control signal comprising S first sub-segments for the pixel circuit row, a duration of the first sub-segment being m*t, where m is a positive integer; wherein the pixel circuit comprises a first data writing transistor, a first electrode of the first data writing transistor is electrically connected to a data line, and a control terminal of the first data writing transistor is electrically connected to a first scanning driving line, the first scanning driving circuit is electrically connected to the first scanning driving line, wherein an one-frame scanning time T of the display panel comprises a display scanning period and a front-and-back porch period, a duration of the display scanning period is M, and a duration of the front-and-back porch period is N, where M=R*t, N=P*t, T=M+N, wherein S=(R+P)/m, S is a positive integer, and R/m is a positive integer.

### BRIEF DESCRIPTION OF THE DRAWINGS

Other features, objectives and advantages of the present application will become more apparent by reading the following detailed description of the non-limiting embodiments with reference to the drawings, where the same or similar reference numerals denote the same or similar features, and the drawings are not drawn according to the actual scale.

FIG. 1 illustrates a schematic structural diagram of a display panel according to an embodiment of the present application.

FIG. 2 illustrates a schematic structural diagram of a pixel circuit according to an embodiment of the present application.

FIG. 3 illustrates another schematic structural diagram of the pixel circuit according to an embodiment of the present application.

FIG. 4 illustrates yet another schematic structural diagram of the pixel circuit according to an embodiment of the present application.

FIG. 5 illustrates a timing diagram of a first light-emitting driving signal of the display panel according to an embodiment of the present application.

FIG. 6A illustrates a timing diagram of a first scanning driving signal of the display panel according to an embodiment of the present application.

FIG. 6B illustrates a timing diagram of the display panel according to an embodiment of the present application.

FIG. 7 illustrates another timing diagram of the first light-emitting driving signal of the display panel according to an embodiment of the present application.

FIG. 8 illustrates yet another timing diagram of the first light-emitting driving signal of the display panel according to an embodiment of the present application.

FIG. 9 illustrates still another timing diagram of the first light-emitting driving signal of the display panel according to an embodiment of the present application.

FIG. 10 illustrates a timing diagram of the display panel according to an embodiment of the present application.

FIG. 11 illustrates another timing diagram of the display panel according to an embodiment of the present application.

FIG. 12 illustrates yet another timing diagram of the display panel according to an embodiment of the present application.

FIG. 13 illustrates a schematic structural diagram of a first light-emitting driving circuit in the display panel according to an embodiment of the present application.

FIG. 14 illustrates a schematic structural diagram of a first shift register in the display panel according to an embodiment of the present application.

FIG. 15 illustrates a timing diagram corresponding to FIG. 14.

FIG. 16 illustrates another timing diagram corresponding to FIG. 14.

FIG. 17 illustrates a timing diagram of a comparative example.

FIG. 18 illustrates yet another timing diagram of the display panel according to an embodiment of the present application.

FIG. 19 illustrates a timing diagram corresponding to FIG. 4.

FIG. 20 illustrates a schematic structural diagram of a display apparatus according to an embodiment of the present application.

### DETAILED DESCRIPTION

The features and exemplary embodiments of various aspects of the present application will be described in detail below. To make the objectives, technical solutions, and advantages of the present application clear, the present application will be further described in details below with reference to the drawings and specific embodiments. It should be understood that the specific embodiments described herein are intended only to explain the present application rather than to limit the present application. Those skilled in the art may implement the present application without some of these specific details. The following description of the embodiments is only provided for the purpose of better understanding of the present application by showing examples of the present application.

It should be noted that, relational terms such as first, second, etc. are only configured to distinguish one entity or operation from another entity or operation, and do not necessarily require or imply any such actual relationship or order between these entities or operations. Moreover, the terms “include”, “comprise” or any other variants thereof are intended to cover non-exclusive inclusion, such that a process, method, article or device including a series of elements includes not only those elements, but also other elements not explicitly listed, or also includes elements inherent to such a process, method, article or device. In the absence of further restrictions, the elements defined by the sentence “comprise . . . ” do not exclude the existence of other identical elements in the process, method, article or device including the elements.

It should be understood that when describing the structure of a component, when a layer or area is referred to as being “on” or “above” another layer or another area, it may indicate being directly on another layer or another area, or there also includes other layers or areas between it and another layer or another area. Also, if the component is turned over, the layer or area will be “under” or “below” another layer or another area.

It should be understood that the term “and/or” as used herein describes only the association relationship of the associated objects and represents that three relationships may exist. For example, A and/or B may represent: only A exists, A and B exist at the same time, and only B exists. In addition, the character “/” herein generally indicates an “or” relationship between the associated objects.

In the embodiments of the present application, the term “electrical connection” may refer to the direct electrical connection of two components, or it may refer to the electrical connection between two components via one or more other components. The term “drive” may refer to “control” or “operate”. The display panel may be a display apparatus or a module/part of a display apparatus.

It is apparent to those skilled in the art that various modifications and changes may be made in the present application without departing from the gist or scope of the present application. Therefore, the present application is intended to cover modifications and changes of the present application that fall within the scope of the corresponding claims (claimed technical solutions) and their equivalents. It should be noted that the implementation methods provided in the embodiments of the present application, if not conflicted, may be combined with each other.

The embodiments of the present application provide a display panel and a display apparatus. Various embodiments of the display panel and the display apparatus will be described below in conjunction with the drawings.

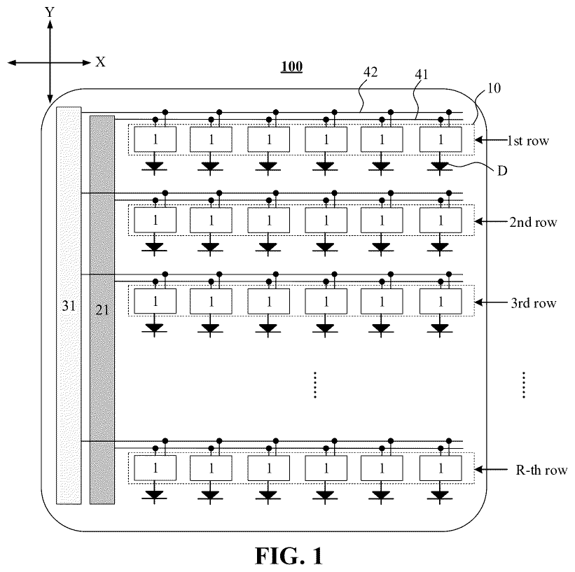

As shown in FIG. 1, the display panel 100 provided in the embodiments of the present application includes a pixel circuit 1, a first scanning driving circuit 21 and a first light-emitting driving circuit 31.

The pixel circuit 1 is electrically connected to the light-emitting element D, and the pixel circuit is configured to drive the light-emitting element to emit light. The light-emitting element may include a micro LED or a min LED or an OLED, etc.

A plurality of pixel circuits 1 are arranged into a pixel circuit row 10 in a first direction X, and R pixel circuit rows 10 are arranged in a second direction Y, and the first direction X and the second direction Y intersect with each other. In FIG. 1, the first row, the second row, the third row . . . the R-th row respectively represent the first pixel circuit row, the second pixel circuit row, the third pixel circuit row . . . the R-th pixel circuit row. It is understandable that R is a positive number.

The first scanning driving circuit 21 provides a first scanning driving signal Scan1 for the pixel circuit row 10, wherein the first scanning driving circuit 21 scans a row of pixel circuits 1 for a duration of t. The first scanning driving signal is configured to control whether the data voltage can be written into the pixel circuit 1. For example, when the first scanning driving signal is at an active level, the data voltage is written into the pixel circuit 1.

Exemplarily, the first scanning driving circuit 21 is electrically connected to multiple pixel circuits 1 in the same row through the first scanning driving line 41. In other words, the first scanning driving signals connected to multiple pixel circuits in the same pixel circuit row are the same.

The first light-emitting driving circuit 31 provides a first light-emitting control signal for the pixel circuit row 10. It is understandable that the first light-emitting control signal is configured to control whether the light-emitting element of the display panel emits light. Specifically, when the first light-emitting control signal is at an active level (for example, the active level is a low level), the light-emitting element emits light; when the first light-emitting control signal is at a cut-off level (for example, the cut-off level is a high level), the light-emitting element does not emit light.

Exemplarily, the first light-emitting driving circuit 31 is electrically connected to multiple pixel circuits 1 in the same row through the first light-emitting control signal line 42. In other words, the first light-emitting control signals connected to multiple pixel circuits in the same pixel circuit row are the same.

It should be noted that FIG. 1 takes the case where only one side in the first direction X is provided with the first scanning driving circuit 21 and the first light-emitting driving circuit 31 as an example, which is not configured to limit the present application. For example, in other examples, both sides in the first direction may be provided with a first scanning driving circuit each, and/or both sides in the first direction may be provided with a first light-emitting driving circuit each.

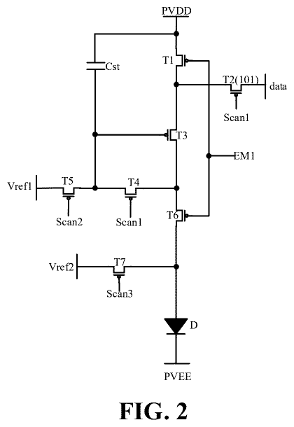

Exemplarily, as shown in any one of FIGS. 2 to 4, the pixel circuit 1 includes a first data writing transistor 101, the first electrode of the first data writing transistor 101 is electrically connected to the data line data, the control end of the first data writing transistor 101 is electrically connected to the first scanning driving line 41, and the first scanning driving line 41 is electrically connected to the first scanning driving circuit 21.

As an example, the pixel circuit is a 7T1C architecture as shown in FIG. 2, the transistor T2 is configured to write the data voltage on the data line data into the driving transistor T3, the driving transistor T3 is configured to generate a driving current, the transistor T4 is configured to compensate the threshold voltage of the driving transistor T3, the transistor T5 is configured to transmit the reset signal on the first reset signal line Vref1 to the gate of the driving transistor T3, the capacitor Cst is configured to maintain the gate potential of the driving transistor T3, the transistor T7 is configured to transmit the reset signal on the second reset signal line Vref2 to the first electrode of the light-emitting element D, and the transistor T1 and the transistor T6 are configured to control whether the light-emitting element D emits light. In addition, Scan1~Scan3 are all scanning driving signals, transistor T2 is the first data writing transistor 101, and EM1 is the first light-emitting control signal.

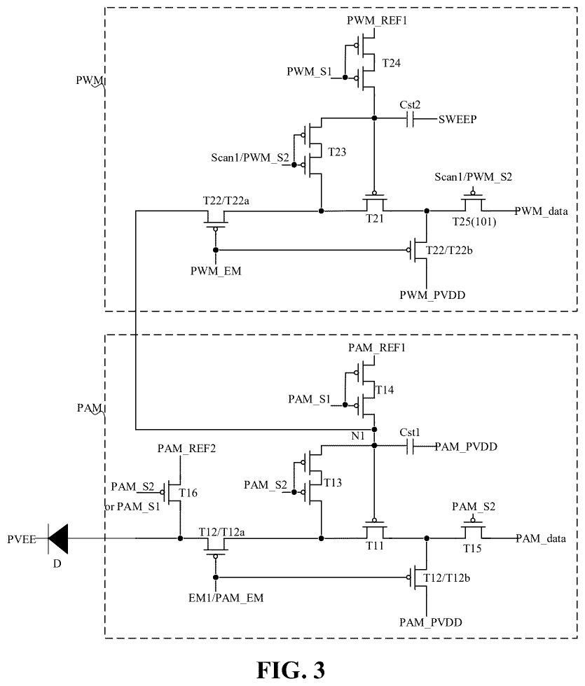

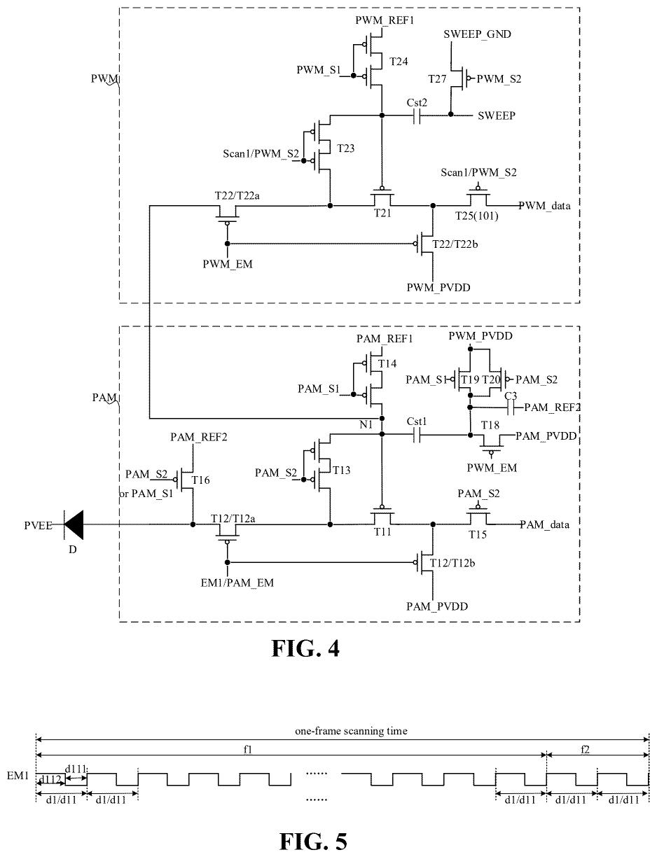

As another example, the pixel circuit is the 13T2C architecture shown in FIG. 3, or the pixel circuit is the 17T3C architecture shown in FIG. 4. In the structures shown in FIG. 3 and FIG. 4, the pixel circuit includes a PWM (Pulse Width Modulation) module and a PAM (Pulse Amplitude Modulation) module. The pulse width modulation module PWM is electrically connected to the pulse amplitude modulation module PAM, and the pulse amplitude modulation module PAM is electrically connected to the light-emitting element D.

The combination of the PWM module and the PAM module can control the intensity of the driving current and the duration of the driving current to control the light-emitting state of the light-emitting element. Specifically, the PAM module is configured to control the amplitude of the driving current, and the PWM module is configured to adjust the pulse width of the voltage applied to the first electrode of the light-emitting element. The PWM module adjusts the pulse width of the voltage applied to the light-emitting element, that is, the PWM module adjusts the actual emission period of the driving current applied to the light-emitting element, and at the same time, the driving current applied to the light-emitting element is maintained at a constant level to adjust the grayscale or brightness displayed by the light-emitting element, rather than only adjusting the grayscale or brightness displayed by the light-emitting element by adjusting the magnitude of the driving current applied to the light-emitting element. Therefore, the PAM module can provide a driving current to the light-emitting element so that the light-emitting element is driven with the best luminous efficiency, and adjust the grayscale or brightness displayed by the light-emitting element by adjusting the light-emitting duty cycle of the light-emitting element (that is, the emission period of the light-emitting element) through the PWM module.

In the embodiments of the present application, the first scanning driving circuit 21 is electrically connected to the PWM module, and the first light-emitting driving circuit 31 is electrically connected to the PAM module.

Specifically, referring to FIG. 3, in the PAM module, the transistor T15 is configured to write the data voltage on the data line PAM_data into the driving transistor T11, the driving transistor T11 is configured to generate a driving current, the transistor T13 is configured to compensate for the threshold voltage of the driving transistor T11, the transistor T14 is configured to transmit the reset signal on the reset signal line PAM_REF1 to the gate of the driving transistor T11, the capacitor Cst1 is configured to maintain the gate potential of the driving transistor T11, the transistor T16 is configured to transmit the reset signal on the reset signal line PAM_REF2 to the first electrode of the light-emitting element D, and the transistor T12a and the transistor T12b are configured to control whether the light-emitting element D emits light. In the PWM module, transistor T25 is configured to write the data voltage on the data line PWM_data into the driving transistor T21, the driving transistor T21 is configured to generate a driving current, the transistor T23 is configured to compensate the threshold voltage of the driving transistor T21, the transistor T24 is configured to transmit the reset signal on the reset signal line PWM_REF1 to the gate of the driving transistor T21, the capacitor Cst2 is configured to couple the signal of the frequency-sweep signal terminal SWEEP to the gate of the driving transistor T21, and the transistor T22a and the transistor T22b are configured to control whether the driving current of the driving transistor T21 is written into the N1 node of the PAM module.

The similarities between FIG. 4 and FIG. 3 are not repeated here, and the differences include: in the PAM module, the transistor T27 is configured to reset the scanning signal terminal SWEEP, and the transistors T18, T19, T20 and the capacitor C3 are configured to eliminate the influence of the voltage drop of the power supply signal PVDD.

Specifically, the transistor T25 in the PWM module is used as the first data writing transistor 101, and the scanning signal PWM_S2 provided by the first scanning driving circuit 21 to the gate of the transistor T25 is used as the first scanning driving signal. The PAM module includes a light-emitting control transistor T12, and the first light-emitting driving circuit 31 is electrically connected to the gate of the light-emitting control transistor T12 in the PAM module. The light-emitting control signal line PAM_EM provided by the first light-emitting driving circuit 31 to the gate of the light-emitting control transistor T12 is the first light-emitting control signal.

It should be noted that FIGS. 2 to 4 are only some examples and are not used to limit the specific structure of the pixel circuit. For example, the pixel circuit can be a pixel circuit of other architectures.

As shown in FIG. 5, in a frame scanning time of the display panel, the first light-emitting control signal EM1 includes S first sub-segments d1, wherein the duration of the first sub-segment is m*t, and S and m are positive integers.

One frame scanning time of the display panel includes a display scanning period f1 and a front-and-back porch period f2, the duration of the display scanning period is M, and the duration of the front-and-back porch period is N; M=R*t, N=P*t, the duration of one frame scanning time of the display panel is T, T=M+N, P is a positive integer; wherein S=(R+P)/m, S is a positive integer, and R/m is a positive integer. In the present application, the symbol “*” represents multiplication.

It can be understood that the total duration of the S first sub-segments d1 is S*m*t, T=S*m*t. In addition, the display scanning period f1 includes R/m first sub-segments, and the front-and-back porch period f2 includes P/m first sub-segments. P is a positive integer, and P/m is a positive integer. R/m is a positive integer and P/m is a positive integer, so that the first sub-segments of the first light-emitting control signal can be evenly distributed in the scanning display stage, and can be evenly distributed in the front-and-back porch stages.

The front-and-back porch period f2 is located between the display scanning periods f1 of the adjacent display frames. The front-and-back porch period f2 can be configured to prepare and transmit the image data to provide the display driver chip (IC) with enough time to prepare for receiving and processing the next frame of image data, so that the display driver chip can complete the processing and output of the current frame data before receiving the next frame of image data, avoiding problems such as data loss and display abnormality.

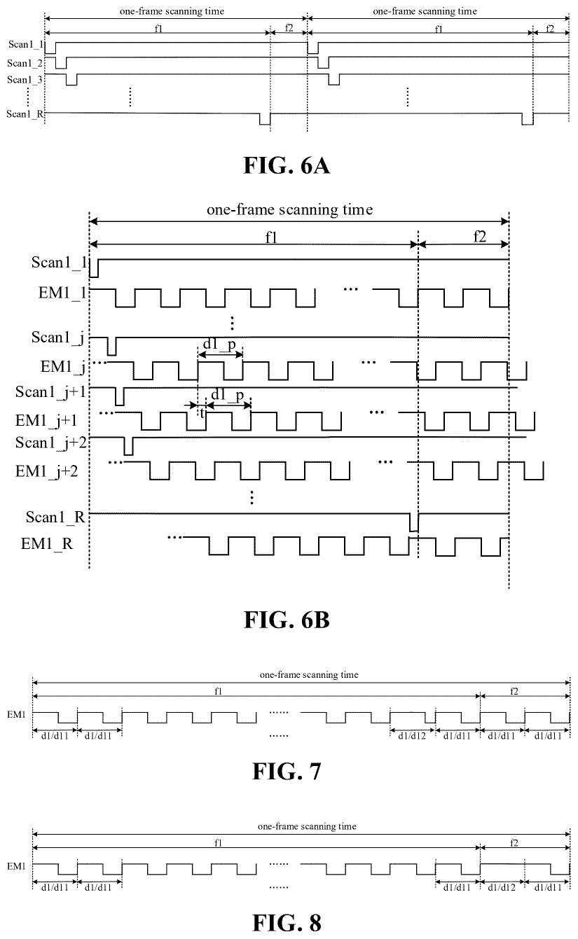

Exemplarily, as shown in FIG. 6A, Scan1_1~Scan1_R represent the first scanning driving signals respectively connected to the first pixel circuit row to the R-th pixel circuit row. In the display scanning period f1, the first scanning driving signals Scan1_1~Scan1_R are respectively active levels (for example, the active level is a low level). In other words, in the display scanning period f1 of one frame scanning time of the display panel, the first scanning driving circuit 21 scans the first row of pixel circuits to the R-th row of pixel circuits row by row, and the scanning time required for the R pixel circuit rows is R*t.

Specifically, FIG. 6B shows the first scanning driving signal Scan1_1 and the first light-emitting control signal EM1_1 corresponding to the 1st pixel circuit row, the first scanning driving signal Scan1_j and the first light-emitting control signal EM1_j corresponding to the j-th pixel circuit row, the first scanning driving signal Scan1_j+1 and the first light-emitting control signal EM1_j+1 corresponding to the j+1-th pixel circuit row, the first scanning driving signal Scan1_j+2 and the first light-emitting control signal EM1_j+2 corresponding to the j+2-th pixel circuit row, and the first scanning driving signal Scan1_R and the first light-emitting control signal EM1_R corresponding to the R-th pixel circuit row.

In the front-and-back porch period f2, the first scanning driving signal S1 is maintained at a cut-off level (e.g., a high level). That is, in the front-and-back porch period f2, the first data writing transistor in the pixel circuit is maintained at a cut-off state.

The first light-emitting control signal is usually a periodic signal, and a first sub-segment can be understood as a cycle of the first light-emitting control signal. In a frame scanning time, it is equivalent to dividing the first light-emitting control signal into S cycles on average, and the duration of each cycle is m*t.

It can be understood that in the embodiments of the present application, in one frame scanning time of the display panel, the first sub-segments d1 are distributed not only in the display scanning period f1, but also in the front-and-back porch period f2.

The first light-emitting control signal is configured to control whether the light-emitting element of the display panel emits light. In at least one first sub-segment, the duty cycle of the active level of the first light-emitting control signal is greater than 0, so that the light-emitting element can emit light in at least one first sub-segment. Exemplarily, in at least one first sub-segment d1 within the display scanning period f1, the duty cycle of the active level of the first light-emitting control signal is greater than 0, and, in at least one first sub-segment d1 within the front-and-back porch period f2, the duty cycle of the active level of the first light-emitting control signal is greater than 0, so that the light-emitting element can emit light multiple times within one frame scanning time.

For example, in S1 first sub-segments, the duty cycle of the active level of the first light-emitting control signal is greater than 0. It can be understood that within one frame scanning time, the number of times the light-emitting element emits light is S1, S1≤S.

In the related art, one frame scanning time only includes the display scanning period, and does not consider the front-and-back porch period. In this way, the multiple light emissions of the light-emitting element can only be concentrated in the display scanning period, which causes the first light-emitting driving circuit to be prone to uneven load problems, affecting the display effect.

In the embodiments of the present application, one frame scanning time includes not only the display scanning period, but also the front-and-back porch period, so that the multiple light emissions of the light-emitting element can be distributed in all the time of one frame scanning time, and the light-emitting element can emit light not only in the display scanning period, but also in the front-and-back porch period, thereby avoiding the multiple light emissions of the light-emitting element being concentrated in the display scanning period, so that the number of pixel circuit rows driven by the first light-emitting driving circuit at each moment is the same, thereby reducing the load difference of the first light-emitting driving circuit, and improving the display effect.

In some embodiments, as shown in FIG. 5, the first sub-segment d1 includes a first-type sub-segment d11, and the duty cycle of the active level of the first light-emitting control signal EM1 in the first-type sub-segment d11 is greater than 0 and less than 1. In one frame scanning time, the number of the first-type sub-segments d11 is greater than 1, and the duty cycles of the active levels of the first light-emitting control signals EM1 in different first-type sub-segments d11 are the same.

As an example, in one frame scanning time, the number of the first-type sub-segments d11 is S1, S1≤S, and the duty cycles of the active levels of the first light-emitting control signals EM1 in S1 first-type sub-segments d11 are the same.

As described in the above embodiments, the duration of different first sub-segments d1 is m*t, that is, the duration of different first-type sub-segments d11 is m*t. When the duty cycles of the active levels of the first light-emitting control signals EM1 in different first-type sub-segments d11 are the same, the durations of the active levels of the first light-emitting control signals EM1 in different first-type sub-segments d11 are the same, and the durations of the cut-off levels of the first light-emitting control signals EM1 in different first-type sub-segments d11 are the same.

The larger the duty cycle of the active level of the first light-emitting control signal EM1 is, the longer the light-emitting duration of the light-emitting element is; conversely, the smaller the duty cycle of the active level of the first light-emitting control signal EM1 is, the shorter the light-emitting duration of the light-emitting element is.

In this embodiment, the duty cycles of the active levels of the first light-emitting control signals in different first-type sub-segments are the same, which can make the light-emitting brightness of the light-emitting element in different first-type sub-segments uniform, thereby further reducing the load difference of the first light-emitting driving circuit and improving the display effect.

In other examples, it can also be set that the duty cycles of the active levels of the first light-emitting control signals in at least two first-type sub-segments are different.

In some embodiments, as shown in FIG. 5, the first sub-segment d1 includes a first-type sub-segment d11, and the duty cycle of the active level of the first light-emitting control signal EM1 in the first-type sub-segment d11 is a, 0<a<0.5, and the number of the first-type sub-segments d11 in one frame scanning time of the display panel is S1, and S1=S.

In each first-type sub-segment d11, the first light-emitting control signal EM1 includes an active level, so that the light-emitting element emits light once in each first-type sub-segment d11, the total number of light-emitting times of the light-emitting element in one frame scanning time is S, the total number of light-emitting times of the light-emitting element in the display scanning period is R/m, and the total number of light-emitting times of the light-emitting element in the front-and-back porch periods is P/m.

In this embodiment, the S times of light emissions of the light-emitting element are averaged in all the time of one frame scanning time, so that not only can the light-emitting element have R/m times of light emissions evenly distributed in the display scanning period, but also can have P/m times of light emissions evenly distributed in the front-and-back porch period, so as to avoid the multiple light emissions of the light-emitting element being concentrated in the display scanning period, so that the number of pixel circuit rows driven by the first light-emitting driving circuit at each moment is the same, thereby reducing the load difference of the first light-emitting driving circuit and improving the display effect.

In some embodiments, as shown in FIG. 7, the first sub-segment d1 includes a first-type sub-segment d11 and a second-type sub-segment d12, and the duty cycle of the active level of the first light-emitting control signal EM1 in the first-type sub-segment d11 is a, and the duty cycle of the active level of the first light-emitting control signal EM1 in the second-type sub-segment d12 is b, 0≤b<a<0.5. In one frame scanning time of the display panel, the number of the first-type sub-segments d11 is S1, and the number of the second-type sub-segments d12 is S2, S1+S2=S, wherein S1 and S2 are both positive integers.

It can be understood that the duty cycle of the active level of the first light-emitting control signal EM1 in the first-type sub-segment d11 is the ratio of the duration of the active level to the duration of the first-type sub-segment. In the embodiments of the present application, b=0 means that the duty cycle of the cut-off level of the first light-emitting control signal EM1 in the second-type sub-segment d12 is 1. The duty cycle of the cut-off level of the first light-emitting control signal EM1 in the first-type sub-segment d11 is 1-a, and the duty cycle of the active level of the first light-emitting control signal EM1 in the second-type sub-segment d12 is 1-b, 0.5<1-a<1-b≤1.

As an example, 0<b<a<0.5, in this case, the first light-emitting control signal EM1 includes an active level in both the first-type sub-segment d11 and the second-type sub-segment d12, so that the light-emitting element can emit light in both the first-type sub-segment d11 and the second-type sub-segment d12, and because a≠b, the light-emitting durations of the light-emitting element in the first-type sub-segment d11 and the second-type sub-segment d12 are different, and thus the light-emitting brightness of the light-emitting element in the first-type sub-segment d11 and the second-type sub-segment d12 are different, which is conducive to improving the grayscale resolution under low grayscale images, so that the light and dark changes of the displayed image can be more delicate.

As another example, as shown in FIGS. 8, 0=b<a<0.5, in this case, the first light-emitting control signal EM1 includes an active level in the first-type sub-segment d11, and the first light-emitting control signal EM1 is maintained at a cut-off level in the second-type sub-segment d12, so that the light-emitting element can emit light in the first-type sub-segment d11, and the light-emitting element does not emit light in the second-type sub-segment d12. Exemplarily, the display panel includes a reused electrode. Since the light-emitting element does not emit light in the second-type sub-segment, the reused electrode in the second-type sub-segment is configured to transmit a touch signal for identifying the touch signal. The reused electrode in the first-type sub-segment is configured to transmit a display driving signal to drive the light-emitting element to emit light.

In some embodiments, S1>S2.

As an example, 0=b<a<0.5, and S1>S2. In the case of b=0, it can be understood that the larger the value of S1 is, the greater the number of times the light-emitting element emits light within one frame scanning time is. In this embodiment, S1 is designed to be greater than S2, which can ensure that the light-emitting element emits more light within one frame, thereby better ensuring the light-emitting effect of the light-emitting element within one frame time.

As another example, 0<b<a<0.5, and S1>S2.

In some embodiments, as shown in FIG. 8, at least one second-type sub-segment d12 is located in the front-and-back porch period f2.

As an example, 0=b<a<0.5, and at least one second-type sub-segment d12 is located in the front-and-back porch period f2. The display driver chip outputs image data in the display scanning stage and prepares image data in the front-and-back porch period. In the case of b=0, for example, the touch signal can be identified in the second-type sub-segment, and at least one second-type sub-segment is set in the front-and-back porch period, so that the touch recognition and image data output can be separated to avoid interference between the two, thereby ensuring the accuracy of the image data output and the accuracy of touch recognition.

As another example, 0<b<a<0.5, and at least one second-type sub-segment d12 is located in the front-and-back porch period f2.

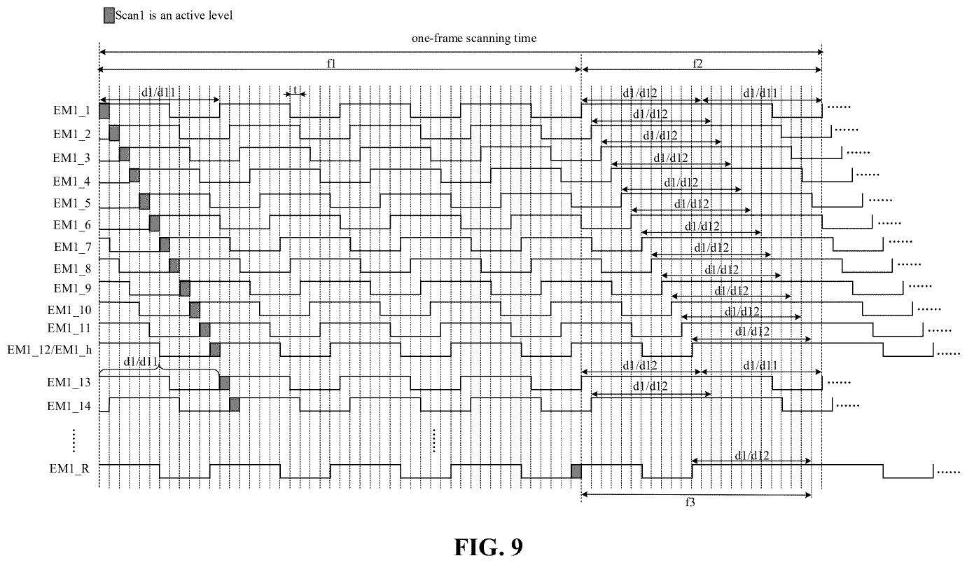

In some embodiments, as shown in FIG. 9, EM1_1~EM1_R represent the first light-emitting control signals connected to the 1st pixel circuit row to the R-th pixel circuit row. It can be understood that in FIG. 9, the first light-emitting control signal corresponding to the 1st pixel circuit row is EM_1, the first light-emitting control signal corresponding to the 2nd pixel circuit row is EM_2, the first light-emitting control signal corresponding to the m-th pixel circuit row is EM_m, and so on, the first light-emitting control signal corresponding to the R-th pixel circuit row is EM_R.

In addition, in FIG. 9 to FIG. 12, the active levels of the first scanning driving signals Scan1 corresponding to the 1st pixel circuit row to the R-th pixel circuit row are indicated by gray boxes.

As shown in FIG. 6B, within the same frame scanning time of the display panel, the p-th first sub-segment d1_p after the active level of the first scanning driving signal Scan1_j corresponding to the j-th pixel circuit row and the p-th first sub-segment d1_p after the active level of the first scanning driving signal Scan1_j+1 corresponding to the j+1-th pixel circuit row are spaced by a duration of t.

For example, as shown in FIG. 9, p=1, the start time of the 1st first sub-segment d1 of the first light-emitting control signal EM1_1 after the 1st pixel circuit row is scanned is spaced by t from the start time of the 1st first sub-segment d1 of the first light-emitting control signal EM1_2 after the 2nd pixel circuit row is scanned; the start time of the 1st first sub-segment d1 of the first light-emitting control signal EM1_2 after the 2nd pixel circuit row is scanned is spaced by t from the start time of the 1st first sub-segment d1 of the first light-emitting control signal EM1_3 after the 3rd pixel circuit row is scanned; the start time of the 1st first sub-segment d1 of the first light-emitting control signal EM1_3 after the 3rd pixel circuit row is scanned is spaced by t from the start time of the 1st first sub-segment d1 of the first light-emitting control signal EM1_4 after the 4-th pixel circuit row is scanned; and so on.

In this embodiment, it is equivalent to spacing the light-emitting periods of two adjacent pixel circuit rows by a duration of t to ensure the overall display effect.

In some embodiments, as shown in FIG. 9, within the same frame scanning time of the display panel, the first light-emitting control signal corresponding to each pixel circuit row includes the second-type sub-segment d12, and the second-type sub-segments d12 in the first light-emitting control signals EM1_1~EM1_R are all within a target time period f3, and the duration of the target time period f3 is less than the duration M of the display scanning stage f1.

Exemplarily, the numbers of the second-type sub-segments d12 in the first light-emitting control signals EM1 corresponding to different pixel circuit rows can be the same. The relative positions of the second-type sub-segments d12 corresponding to at least two pixel circuit rows are different, and the relative position is the target number of the first-type sub-segments d11 between the second-type sub-segment d12 corresponding to the pixel circuit row and the active level of the first scanning driving signal corresponding to the pixel circuit row.

As an example, 0=b<a<0.5, and the second-type sub-segments of the first light-emitting control signals corresponding to the R pixel circuit rows are within a target period, and in a case of b=0, the light-emitting element does not emit light in the second-type sub-segment, for example, the touch signal can be recognized in the second-type sub-segment. In this embodiment, the touch recognition and display image driving can be performed separately to avoid interference between the two, thereby ensuring the accuracy of display driving and touch recognition; in addition, in this embodiment, the second-type sub-segments corresponding to the R pixel circuit rows that do not emit light are controlled within a target period, so that the display uniformity can be improved.

As another example, 0<b<a<0.5, and the second-type sub-segments of the first light-emitting control signals respectively corresponding to the R pixel circuit rows are within a target period.

In some embodiments, as shown in FIG. 9, the duration M of the display scanning period f1 is greater than the duration N of the front-and-back porch period f2, and the duration of the target period f3 is less than N.

During the display scanning period f1, the first scanning driving circuit scans R rows of the pixel circuits row by row, and sets the duration of the display scanning stage to be greater than the duration of the front-and-back porch period, which can ensure that the scanning duration for each row of pixel circuits is sufficient, thereby ensuring the adequacy of data voltage writing.

As an example, 0=b<a<0.5, and M>N, the duration of the target period f3 is less than N. In this example, the non-light-emitting second-type sub-segments corresponding to the R pixel circuit rows are controlled within the target period with a shorter duration, which can further improve the display uniformity.

As another example, 0<b<a<0.5, and M>N, the duration of the target period f3 is less than N.

In some embodiments, as shown in FIG. 9, the second-type sub-segment d12 in the first light-emitting control signal corresponding to the j-th pixel circuit row is located within the front-and-back porch period f2, where 1≤j≤R, and j is a positive integer.

The j-th pixel circuit row is any one of the 1st pixel circuit row to the R-th pixel circuit row, that is, the second-type sub-segment d12 in the first light-emitting control signal corresponding to any one of pixel circuit rows is located within the front-and-back porch period f2.

For example, the second-type sub-segment d12 in the first light-emitting control signal EM1_1 corresponding to the 1st pixel circuit row is located within the front-and-back porch period f2; the second-type sub-segment d12 in the first light-emitting control signal EM1_2 corresponding to the 2nd pixel circuit row is located within the front-and-back porch period f2; the second-type sub-segment d12 in the first light-emitting control signal EM1_m corresponding to the m-th pixel circuit row is located within the front-and-back porch period f2, and so on, the second-type sub-segment d12 in the first light-emitting control signal EM1_R corresponding to the R-th pixel circuit row is located within the front-and-back porch period f2.

It should be noted that FIG. 9 illustrates an example where the number of second-type sub-segments d12 in the first light-emitting control signal corresponding to the j-th pixel circuit row is 1. The number of second-type sub-segments d12 in the first light-emitting control signal corresponding to the j-th pixel circuit row may also be plural, and the plurality of second-type sub-segments d12 in the first light-emitting control signal corresponding to the j-th pixel circuit row are located within the front-and-back porch period f2.

As an example, 0=b<a<0.5, and the second-type sub-segment d12 in the first light-emitting control signal corresponding to the j-th pixel circuit row is located within the front-and-back porch period f2. The display driver chip outputs the image data in the display scanning stage and prepares the image data in the front-and-back porch period. In the case where b=0, the light-emitting element does not emit light in the second-type sub-segment, and for example, the touch signal recognition can be performed in the second-type sub-segment. The second-type sub-segment d12 in the first light-emitting control signal corresponding to the j-th pixel circuit row is set in the front-and-back porch period f2, which can better separate the output of touch recognition and image data to avoid interference between the two, thereby ensuring the accuracy of the image data output and the accuracy of touch recognition.

As another example, 0<b<a<0.5, and the second-type sub-segment d12 in the first light-emitting control signal corresponding to the j-th pixel circuit row is located within the front-and-back porch period f2.

Exemplarily, within the same one-frame scanning time of the display panel, the first light-emitting control signal corresponding to each pixel circuit row includes the second-type sub-segment d12, and the second-type sub-segments d12 in the first light-emitting control signals EM1_1 to EM1_R are all within a target period f3, the duration of the target period f3 is less than the duration N of the front-and-back porch stage f2, and M<N, which can be achieved by the following embodiments. In some embodiments, h pixel circuit rows are arranged in the second direction to form a pixel circuit group, and R pixel circuit rows include a plurality of pixel circuit groups.

Exemplarily, the 1st pixel circuit row to the h-th pixel circuit row form a pixel circuit group, the h+1-th pixel circuit row to the 2h-th pixel circuit row form another pixel circuit group, and so on. Each pixel circuit group includes h pixel circuit rows.

For example, h=m, R pixel circuit rows include R/m pixel circuit groups, where R/m is a positive integer.

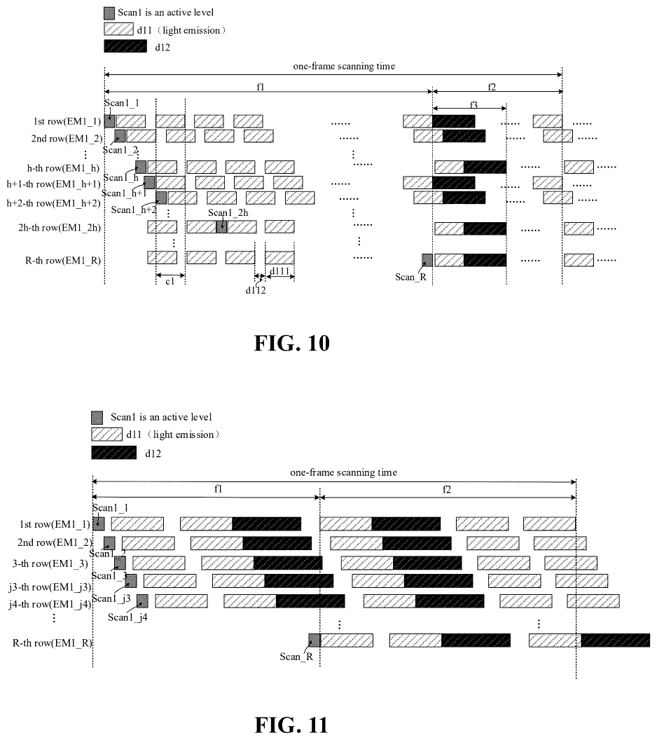

As shown in FIG. 10, the first light-emitting control signals corresponding to the 1st pixel circuit row to the h-th pixel circuit row are denoted by EM1_1 to EM1_h, respectively, and the first light-emitting control signals corresponding to the h+1-th pixel circuit row to the 2h-th pixel circuit row are denoted by EM1_h+1 to EM1_2h, respectively, and so on; and the first light-emitting control signal corresponding to the R-th pixel circuit row is denoted by EM1_R. The first light-emitting control signals EM1_1 to EM1_h are the first light-emitting control signals corresponding to different pixel circuit rows in the 1st pixel circuit group, and the first light-emitting control signals EM1_h+1 to EM1_2h are the first light-emitting control signals corresponding to different pixel circuit rows in the 2nd pixel circuit group.

Within the same one-frame scanning time of the display panel, the relative positions of the second type sub-segments d12 in the first light-emitting control signals corresponding to different pixel circuit rows in the same pixel circuit group are the same, and the relative position of the second-type sub-segment d12 in the first light-emitting control signal corresponding to the j-th pixel circuit row is different from the relative position of the second-type sub-segment d12 in the first light-emitting control signal corresponding to the j+h-th pixel circuit row; and the relative position is the target number of the first-type sub-segments b11 between the active level of the first scanning driving signal and the second-type sub-segment d12 in the first light-emitting control signal corresponding to the pixel circuit row.

It should be noted that, to clearly illustrate the arrangement rules of the second-type sub-segments corresponding to a plurality of pixel circuit rows in FIGS. 10 to 12, rectangular boxes filled with diagonal lines in FIGS. 10 to 12 denote the periods during which the first light-emitting control signal EM1 in the first-type sub-segment d11 is at the active level. It can be understood that the rectangular boxes filled with diagonal lines also denote light-emitting periods of the light-emitting element, and other periods outside the rectangular boxes filled with diagonal lines are all non-light-emitting periods of the light-emitting element. For example, referring to FIGS. 5 and 10 in combination. The first-type sub-segment d11 includes an active level period d111 and a cut-off level period d112. The first light-emitting control signal EM1 is at the active level during the active level period d111, and the first light-emitting control signal EM1 is at the cut-off level during the cut-off level period d112. In FIGS. 10 to 12, the rectangular boxes filled with diagonal lines denote the active level periods d111, and the interval between adjacent rectangular boxes filled with diagonal lines denotes the cut-off level periods d112.

The first light-emitting control signal corresponding to the 1st pixel circuit row is EM1_1, the first scanning driving signal corresponding to the 1st pixel circuit row is Scan1_1, and the target number corresponding to the 1st pixel circuit row is the number of first-type sub-segments b11 between the 1st second-type sub-segment d12 of the first light-emitting control signal EM1_1 and the active level (low level) of the first scanning driving signal Scan1_1.

The first light-emitting control signal corresponding to the 2nd pixel circuit row is EM1_2, the first scanning driving signal corresponding to the 2nd pixel circuit row is Scan1_2, and the target number corresponding to the 2nd pixel circuit row is the number of first-type sub-segments b11 between the 1st second-type sub-segment d12 of the first light-emitting control signal EM1_2 and the active level (low level) of the first scanning driving signal Scan1_2.

By analogy, the first light-emitting control signal corresponding to the R-th pixel circuit row is EM1_R, the first scanning driving signal corresponding to the 2nd pixel circuit row is Scan1_R, and the target number corresponding to the R-th pixel circuit row is the number of first-type sub-segments b11 between the 1st second-type sub-segment d12 of the first light-emitting control signal EM1_R and the active level (low level) of the first scanning driving signal Scan1_R.

From the 1st pixel circuit row to the h-th pixel circuit row, the target numbers corresponding to different pixel circuit rows are the same; from the h+1-th pixel circuit row to the 2h-th pixel circuit row, the target numbers corresponding to different pixel circuit rows are the same; from the 2h+1-th pixel circuit row to the 3h-th pixel circuit row, the target numbers corresponding to different pixel circuit rows are the same; and so on.

It can be understood that the j-th pixel circuit row and the j+h-th pixel circuit row belong to different pixel circuit groups, where 1≤j≤R.

Below, h=12 is exemplified for explanation.

From the 1st pixel circuit row to the 12th pixel circuit row, the target numbers corresponding to different pixel circuit rows are the same; from the 13th pixel circuit row to the 24th pixel circuit row, the target numbers corresponding to different pixel circuit rows are the same; from the 25th pixel circuit row to the 36th pixel circuit row, the target numbers corresponding to different pixel circuit rows are the same; and so on.

Additionally, in the case where j=1, the target number corresponding to the 1st pixel circuit row is different from the target number corresponding to the 13th pixel circuit row;

In the case where j=2, the target number corresponding to the 2nd pixel circuit row is different from the target number corresponding to the 14th pixel circuit row;

And so forth;

In the case where j=12, the target number corresponding to the 12th pixel circuit row is different from the target number corresponding to the 24th pixel circuit row; and so on.

In the present embodiment, every h pixel circuit rows are treated as a pixel circuit group. Within the same one-frame scanning time, the relative positions of the second-type sub-segments in the first light-emitting control signals corresponding to the pixel circuit rows in different pixel circuit groups are different. By adjusting the relative positions of the second-type sub-segments corresponding to different pixel circuit groups, the second-type sub-segments corresponding to a plurality of pixel circuit groups can be controlled within one target period, which can improve display uniformity.

In some embodiments, within the same one-frame scanning time of the display panel, the active level of the first scanning driving signal corresponding to the j-th pixel circuit row is before the active level of the first scanning driving signal corresponding to the j+h-th pixel circuit row; the target number corresponding to the j-th pixel circuit row is j1, and the target number corresponding to the j+h-th pixel circuit row is j2, where j1=j2+h.

Within the same one-frame scanning time, the first scanning driving circuit first scans the j-th pixel circuit row, and then scans the j+h-th pixel circuit row.

Exemplarily, the following continues to use h=12 as an example for explanation.

From the 1st pixel circuit row to the 12th pixel circuit row, the target numbers corresponding to different pixel circuit rows are j1; from the 13th pixel circuit row to the 24th pixel circuit row, the target numbers corresponding to different pixel circuit rows are j2. Here, the target number corresponding to the 1st pixel circuit row is j1, the target number corresponding to the 2nd pixel circuit row is j1, and the same applies to the target numbers corresponding to the 3rd pixel circuit row to the 12th pixel circuit row. The target number corresponding to the 13th pixel circuit row is j2, the target number corresponding to the 14th pixel circuit row is j2, and the same applies to the target number corresponding to the 15th pixel circuit row to the 24th pixel circuit row. Here, “target number” has the same meaning as those in the aforementioned embodiments, i.e., the target number corresponding to the 1st pixel circuit row is the number of first-type sub-segments b11 between the 1st second-type sub-segment d12 of the first light-emitting control signal EM1_1 and the active level (low level) of the first scanning driving signal Scan1_1; the first light-emitting control signal corresponding to the 2nd pixel circuit row is EM1_2, and the first scanning driving signal corresponding to the 2nd pixel circuit row is Scan1_2, and the target number corresponding to the 2nd pixel circuit row is the number of first-type sub-segments b11 between the 1st second-type sub-segment d12 of the first light-emitting control signal EM1_2 and the active level (low level) of the first scanning driving signal Scan1_2. By analogy, the first light-emitting control signal corresponding to the R-th pixel circuit row is EM1_R, and the first scanning driving signal corresponding to the 2nd pixel circuit row is Scan1_R, the target number corresponding to the R-th pixel circuit row is the number of first-type sub-segments b11 between the 1st second-type sub-segment d12 of the first light-emitting control signal EM1_R and the active level (low level) of the first scanning driving signal Scan1_R.

The target number corresponding to the 1st pixel circuit row minus the target number corresponding to the 13th pixel circuit row equals 12, the target number corresponding to the 2nd pixel circuit row minus the target number corresponding to the 14th pixel circuit row equals 12, the target number corresponding to the 3rd pixel circuit row minus the target number corresponding to the 15th pixel circuit row equals 12, and so on, the target number corresponding to the 12th pixel circuit row minus the target number corresponding to the 24th pixel circuit row equals 12.

It can be understood that in each pixel circuit group, the duration between the start time of the 1st second-type sub-segment corresponding to the 1st pixel circuit row and the end time of the last second-type sub-segment corresponding to the last pixel circuit row determines the duration occupied by the second-type sub-segment corresponding to the pixel circuit group.

In the present embodiment, it is equivalent to pulling back the second-type sub-segment corresponding to the j+h-th pixel circuit row, so that the second-type sub-segment corresponding to the j+h-th pixel circuit row and the second-type sub-segment corresponding to the j-th pixel circuit row tend to be aligned in time, thereby controlling the second-type sub-segments corresponding to a plurality of pixel circuit groups within a shorter target period to improve display uniformity.

Exemplarily, 0=b<a<0.5, and h=m, i.e., j1=j2+m.

Within the one-frame scanning time, the number of first sub-segments included in the first light-emitting control signal is (R+P)/m, and the duration of each first sub-segment is m*t. As shown in FIG. 10, the first sub-segment d1 of the first light-emitting control signal EM1_1 corresponding to the 1st pixel circuit row and the first sub-segment d1 of the first light-emitting control signal EM1_h+1 corresponding to the (h+1)-th (where h=m) pixel circuit row are aligned in time, or in other words, at the same time instance, the first light-emitting control signal EM1_1 corresponding to the 1st pixel circuit row is the first sub-segment d1, and the first light-emitting control signal EM1_m+1 corresponding to the (m+1)-th pixel circuit row is also the first sub-segment d1. For example, in FIG. 10 in which h=m=12 is taken as an example, in a period c1, the first light-emitting control signal EM1_1 corresponding to the 1st pixel circuit row is the first sub-segment d1, and the first light-emitting control signal EM1_13 corresponding to the 13th pixel circuit row is the first sub-segment d1.

It can be understood that the first sub-segment d1 of the first light-emitting control signal EM1_h corresponding to the h-th pixel circuit row and the first sub-segment d1 of the first light-emitting control signal EM1_2h corresponding to the 2h-th pixel circuit row are aligned in time, where h=m, and m is any value ranging from 1 to R.

In this example, the R pixel circuit rows are divided into R/m pixel circuit groups with m rows per group. For the second-type sub-segment d12, it is equivalent to repeatedly arranging the second-type sub-segment d12 in a period of m pixel circuit rows, so that the second type of sub-segments corresponding to the R pixel circuit rows can be controlled within a shorter target period to improve display uniformity.

The aforementioned examples introduce some implementation methods that can achieve that the second-type sub-segments d12 in the first light-emitting control signals EM1_1 to EM1_R are all within a target period f3, but this is not intended to limit the present application. Those skilled in the art can appropriately modify the aforementioned embodiments to achieve that the second-type sub-segments d12 in the first light-emitting control signals EM1_1 to EM1_R are all within the target period f3.

In some embodiments, as shown in FIG. 10 or FIG. 11, within the same one-frame scanning time of the display panel, the numbers of second-type sub-segments d12 in the first light-emitting control signals corresponding respectively to different pixel circuit rows are the same.

For example, the number of second-type sub-segments d12 in the first light-emitting control signal corresponding to the i1-th pixel circuit row is the same as the number of second-type sub-segments d12 in the first light-emitting control signal corresponding to the i2-th pixel circuit row, where i1≠i2, and 1≤i1≤R, 1≤i2≤R.

As an example, S2=1. As shown in FIG. 10, within the one-frame scanning time of the display panel, the number of second-type sub-segments d12 in the first light-emitting control signal EM1 corresponding to any pixel circuit row is 1. The fewer the number of second-type sub-segments in the first light-emitting control signal corresponding to the pixel circuit row is, the easier it is to make the duration of the target period to which the second-type sub-segments corresponding to the R pixel circuit rows belong shorter.

For example, 0=b<a<0.5 , and S2=1. Alternatively, 0<b<a<0.5, and S2=1.

As another example, S2≥2. As shown in FIG. 11, within the one-frame scanning time of the display panel, the number of second-type sub-segments d12 in the first light-emitting control signal EM1 corresponding to any pixel circuit row is 2. In other examples, the number of second-type sub-segments d12 in the first light-emitting control signal EM1 corresponding to any pixel circuit row may be greater than 2.

In some embodiments, when the numbers of second-type sub-segments in the first light-emitting control signals corresponding respectively to different pixel circuit rows are the same within the same one-frame scanning time of the display panel, as shown in FIG. 11, within the same one-frame scanning time of the display panel, the relative position of the k-th second-type sub-segment d12_k in the first light-emitting control signal EM1_j3 corresponding to the j3-th pixel circuit row is the same as the relative position of the k-th second-type sub-segment d12_k in the first light-emitting control signal EM1_j4 corresponding to the j4-th pixel circuit row, where 1≤j3<j4≤R. It can be understood that j3 and j4 are both positive integers. Here, the relative position is still the target number of first-type sub-segments between the active level of the first scanning driving signal and the second-type sub-segment in the first light-emitting control signal corresponding to the pixel circuit row.

For example, the target number of first-type sub-segments d11 between the k-th second-type sub-segment d12_k in the first light-emitting control signal EM1_j3 corresponding to the j3-th pixel circuit row and the active level (for example, low level) of the first scanning driving signal Scan1_j3 corresponding to the j3-th pixel circuit row is the first number, and the target number of first-type sub-segments d11 between the k-th second-type sub-segment d12_k in the first light-emitting control signal EM1_j4 corresponding to the j4-th pixel circuit row and the active level (for example, low level) of the first scanning driving signal Scan1_j4 corresponding to the j4-th pixel circuit row is also the first number.

In the present embodiment, within the same one-frame scanning time of the display panel, the relative positions of the k-th second-type sub-segments in the first light-emitting control signals corresponding to different pixel circuit rows are set to be the same, which allows the first light-emitting control signals corresponding to the 1st pixel circuit row to the R-th pixel circuit row to be sequentially transmitted, thereby reducing the complexity of the driving timing.

Exemplarily, k is less than or equal to S2. Taking k=2 as an example, within the same one-frame scanning time of the display panel, the relative position of the 1st second-type sub-segment d12 in the first light-emitting control signal EM1_j3 corresponding to the j3-th pixel circuit row is the same as the relative position of the 1st second-type sub-segment d12 in the first light-emitting control signal EM1_j4 corresponding to the j4-th pixel circuit row. The relative position of the 2nd second-type sub-segment d12 in the first light-emitting control signal EM1_j3 corresponding to the j3-th pixel circuit row is the same as the relative position of the 2nd second-type sub-segment d12 in the first light-emitting control signal EM1_j4 corresponding to the j4-th pixel circuit row.

In some embodiments, in the case where S2≥2, as shown in FIG. 11, the two adjacent second-type sub-segments d12 in the first light-emitting control signal EM1 corresponding to the pixel circuit row are spaced by q first-type sub-segments d11. It can be understood that q is an integer greater than or equal to 1.

As an example, 0=b<a<0.5, and the two adjacent second-type sub-segments d12 in the first light-emitting control signal EM1 corresponding to the pixel circuit row are spaced by q first-type sub-segments d11. In this example, the light-emitting element does not emit light in the second-type sub-segment, which is equivalent to dispersing the non-light-emitting second-type sub-segments, thereby avoiding the non-light-emitting stage visible to the human eye.

As another example, 0<b<a<0.5, the two adjacent second-type sub-segments d12 in the first light-emitting control signal EM1 corresponding to the pixel circuit row are spaced by q first-type sub-segments d11. In this example, the light-emitting duration of the light-emitting element in the second-type sub-segment is shorter than the light-emitting duration of the light-emitting element in the first-type sub-segment, which is equivalent to dispersing the second-type sub-segments with shorter non-light-emitting durations, thereby avoiding the flicker problem visible to the human eye.

In other examples, in the case where S2≥2, at least two second-type sub-segments of the first light-emitting control signal corresponding to the pixel circuit row may not be spaced by the first-type sub-segment.

In some embodiments, as shown in FIG. 11, within the same one-frame scanning time of the display panel, the display scanning period f1 and the front-and-back porch period f2 each include the first-type sub-segment d11.

The light-emitting element emits light during the first-type sub-segment d11. In this example, the light-emitting element can emit light during both the display scanning period f1 and the front-and-back porch period f2, thereby improving the display effect.

Exemplarily, within the same one-frame scanning time of the display panel, the number of first-type sub-segments d11 in the display scanning period f1 is greater than the number of first-type sub-segments d11 in the front-and-back porch period f2, that is, R/m>P/m, R>P. For example, R may be much greater than P. As an example, P=1 m, or, P=2 m.

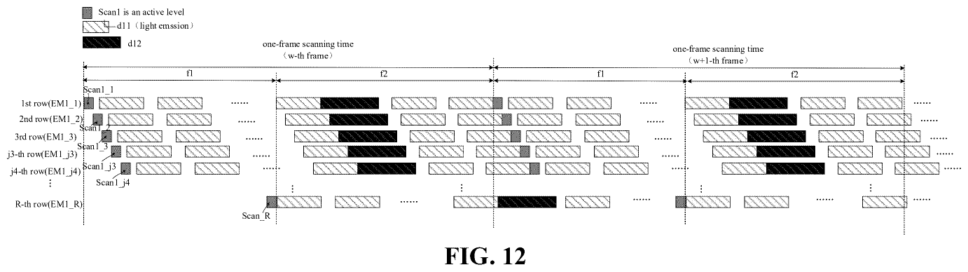

In some embodiments, as shown in FIG. 12, the second-type sub-segment d12 in the first light-emitting control signal EM1 corresponding to the pixel circuit row and the active level (e.g., low level) of the first scanning driving signal Scan1 are spaced by at least one first-type sub-segment b11.

For example, the 1st pixel circuit row corresponds to the first light-emitting control signal EM1_1 and the first scanning driving signal Scan1_1, and the second-type sub-segment d12 in the first light-emitting control signal EM1_1 within the w-th frame and the active level of the first scanning driving signal Scan1_1 within the w+1-th frame are spaced by at least one first-type sub-segment b11, where w is a positive integer.

The 2nd pixel circuit row corresponds to the first light-emitting control signal EM1_2 and the first scanning driving signal Scan1_2, and the second-type sub-segment d12 in the first light-emitting control signal EM1_2 within the w-th frame and the active level of the first scanning driving signal Scan1_2 within the w+1-th frame are spaced by at least one first-type sub-segment b11.

By analogy, the R-th pixel circuit row corresponds to the first light-emitting control signal EM1_R and the first scanning driving signal Scan1_R, and the second-type sub-segment d12 in the first light-emitting control signal EM1_R within the w-th frame and the active level of the first scanning driving signal Scan1_R within the w+1-th frame are spaced by at least one first-type sub-segment b11.

As an example, b=0. In this case, the light-emitting element does not emit light in the second-type sub-segment. If the second-type sub-segment is adjacent to the active level of the first scanning driving signal, that is, after not emitting light, the first scanning driving signal controls the corresponding data voltage to be written into the pixel circuit immediately, the stress effect of the driving transistor in the pixel circuit may cause the final written data voltage to change, which is prone to Mura (uneven display) problems. In the present embodiment, the duty cycle of the cut-off level of the first light-emitting control signal EM1 in the second-type sub-segment d12 is 1, and the second-type sub-segment and the active level of the first scanning driving signal are spaced by the first-type sub-segment, which can avoid the Mura problem.

Exemplarily, the active level (e.g., low level) of the first scanning driving signal Scan1 and the second-type sub-segment d12 in the first light-emitting control signal EM1 corresponding to the pixel circuit row are spaced by at least one first-type sub-segment b11. Also, when the numbers of second-type sub-segments in the first light-emitting control signals corresponding respectively to different pixel circuit rows are the same within the same one-frame scanning time of the display panel, within the same one-frame scanning time of the display panel, the relative position of the k-th second-type sub-segment d12_k in the first light-emitting control signal EM1_j3 corresponding to the j3-th pixel circuit row is the same as the relative position of the k-th second-type sub-segment d12_k in the first light-emitting control signal EM1_j4 corresponding to the j4-th pixel circuit row.

The first light-emitting control signal in any one of the aforementioned embodiments is generated by a first light-emitting driving circuit, and the structure of the first light-emitting driving circuit is exemplarily described below.

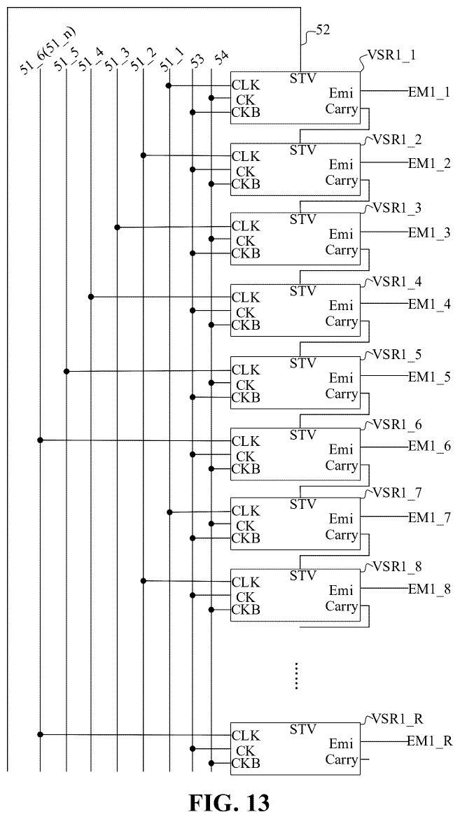

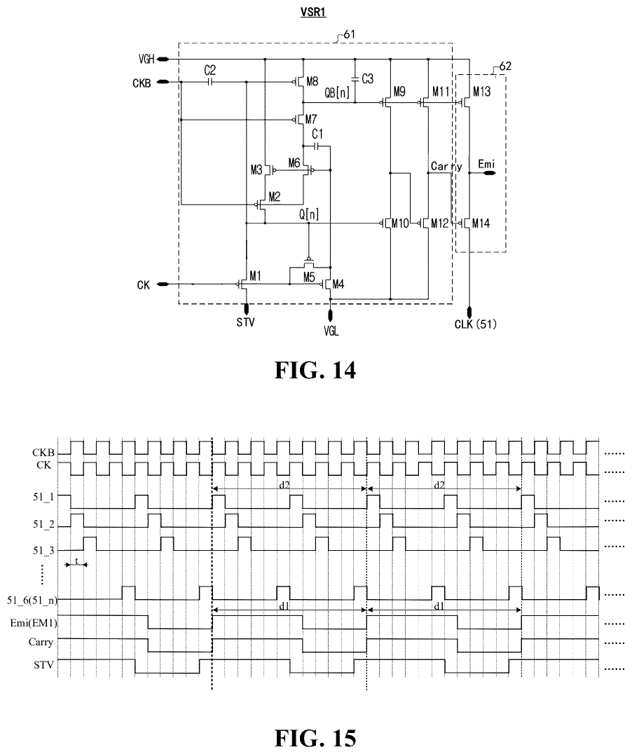

In some embodiments, as shown in FIGS. 13 and 14, the first light-emitting driving circuit 31 includes a plurality of cascaded first shift registers VSR1. The first shift register VSR1 includes a first output transistor M14, a first electrode of the first output transistor M14 is connected to a first clock input terminal CLK, and a second electrode of the first output transistor M14 is connected to an output terminal Emi of the first shift register VSR1, and the output terminal Emi of the first shift register VSR1 outputs the first light-emitting control signal EM1. The first clock input terminal CLK is electrically connected to a first clock signal line 51, and the number of first clock signal lines 51 electrically connected to the first light-emitting driving circuit 31 is n, where n is an integer, R/n is an integer, and m/n is an integer. The duration of the active level of the first light-emitting control signal EM1 in the first sub-segment is less than or equal to t*n.

The first clock signal lines 51 include 1st first clock signal line 51_1 to n-th first clock signal line 51_n, and the w-th first shift register and the w+n-th first shift register are connected to the same first clock signal line.

Exemplarily, in FIG. 13 where n=6 is taken as an example, the 1st first shift register VSR1_1 to the 6th first shift register VSR1_6 are sequentially connected to the 1st first clock signal line 51_1 to the 6th first clock signal line 51_6, the 7th first shift register VSR1_7 to the 12th first shift register VSR1_12 are sequentially connected to the 1st first clock signal line 51_1 to the 6th first clock signal line 51_6, the 13th first shift register VSR1_13 to the 18th first shift register VSR1_18 are sequentially connected to the 1st first clock signal line 51_1 to the 6th first clock signal line 51_6, and so on. It can be understood that the 1st first shift register VSR1_1, the 7th first shift register VSR1_7, the 13th first shift register VSR1_18, etc., are all connected to the 1st first clock signal line 51_1; and the 2nd first shift register VSR1_2, the 8th first shift register VSR1_8, the 14th first shift register VSR1_14, etc., are all connected to the 2nd first clock signal line 51_2, and the others follow the same pattern, which will not be described one by one.

As shown in FIG. 14, the first shift register VSR1 includes a driving module 61 and a gating module 62. The gating module 62 includes a first output transistor M14. An output terminal Carry of the driving module 61 is connected to a trigger signal terminal of the first shift register of the next stage, and the output terminal Carry of the driving module 61 is connected to the gate of the first output transistor M14. The output terminal of the gating module 62 outputs the first light-emitting control signal EM1.

As shown in FIG. 15, FIG. 15 corresponds to a timing diagram of the first shift register connected to the 1st first clock signal line 51_1. Exemplarily, as shown in FIG. 15, the active levels (e.g., low levels) of the first clock signals on the n first clock signal lines 51 need to be shifted back by at least one row scanning time t in sequence, and the active level on the n-th first clock signal line 51_n is shifted back by a duration of n*t relative to the active level on the 1st first clock signal line 51_1.

In addition, the signal output from the output terminal Carry of the driving module 61 and the signal on the first clock input terminal CLK jointly control the first light-emitting control signal EM1 output from the output terminal Emi, that is, the duration of the active level of the first light-emitting control signal EM1 is jointly determined by the duration of the active level of the signal output from the output terminal Carry of the driving module 61 and the duration of the active level of the signal on the first clock input terminal CLK.

The inventors have found that if the duration of the active level of the first light-emitting control signal EM1 in the first sub-segment is greater than t*n, timing conflicts are likely to occur. However, in the present embodiment, by setting the duration of the active level of the first light-emitting control signal EM1 in the first sub-segment to be less than or equal to t*n, the timing conflicts can be avoided.

It should be noted that FIGS. 14 and 15 are only some examples, and are not intended to limit the present application.

In some embodiments, the duration of the active level of the first light-emitting control signal in the first sub-segment is equal to t*n. In this example, the light-emitting duration of the light-emitting element in the first sub-segment can be maximized.

As an example, as shown in FIG. 5, the first light-emitting control signal EM1 includes an active level (low level) in each first sub-segment d1. The duration of the active level of the first light-emitting control signal EM1 in each first sub-segment d1 may be t*n.

As an example, as shown in FIG. 10 or FIG. 11, the first sub-segment includes the first-type sub-segment d11 and the second-type sub-segment d12, and the first light-emitting control signal EM1 includes an active level (low level) in each first-type sub-segment d11, and the duration of the active level of the first light-emitting control signal EM1 in each first-type sub-segment d11 may be t*n. Additionally, the first light-emitting control signal EM1 remains at a cut-off level (high level) in the second-type sub-segment d12.

In some embodiments, as shown in FIG. 15, within the one-frame scanning time of the display panel, the first clock signal on the first clock signal line 51 includes S second sub-segments d2, and the S second sub-segments d2 correspond one-to-one to the S first sub-segments d1.

The first clock signal on the first clock signal line 51 is typically a periodic signal, and one second sub-segment can be understood as one cycle of the first clock signal. Within the one-frame scanning time, it is equivalent to dividing the first clock signal into S cycles on average, and also dividing the first light-emitting control signal into S cycles on average, and the cycles of the first clock signal corresponds one-to-one to the cycles of the first light-emitting control signal.

As shown in FIG. 14, when the first output transistor M14 is turned on, the first clock signal on the first clock signal line 51 is transmitted to the output terminal Emi through the first output transistor M14, and the output terminal Emi outputs the first light-emitting control signal EM1. The timing of the first clock signal on the first clock signal line 51 affects the timing of the first light-emitting control signal EM1.

In the present embodiment, the S second sub-segments of the first clock signal correspond one-to-one to the S first sub-segments of the first light-emitting control signal, which can avoid timing conflicts.

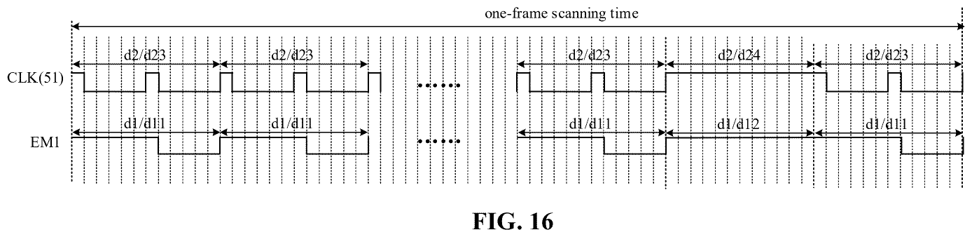

In some embodiments, as shown in FIG. 16, the signal on the first clock signal terminal CLK is the first clock signal, the first sub-segment d1 includes the first-type sub-segment d11, and the duty cycle of the active level of the first light-emitting control signal EM1 in the first-type sub-segment d11 is a, where 0<a<0.5. The second sub-segment d2 includes a third-type sub-segment d23, the third-type sub-segment d23 corresponds to the first-type sub-segment d11, and the number of active pulses (low-level pulses) of the first clock signal in the third-type sub-segment d23 is m/n.

Exemplarily, m=12, n=6, the first clock signal on the first clock signal terminal CLK includes 2 low-level pulses in the third-type sub-segment d23. It can be understood that the low levels of the first clock signal on the first clock signal terminal CLK are spaced by high levels.

Exemplarily, within the one-frame scanning time, the first light-emitting control signal EM1 corresponding to each pixel circuit row includes S first sub-segments d1, where S=(R+P)/m, so that the first sub-segment of the first light-emitting control signal corresponding to the 1st pixel circuit row and the first sub-segment of the first light-emitting control signal corresponding to the m+1-th pixel circuit row can be aligned in time. For example, FIG. 9 illustrates an example where m=h=12. The first sub-segment d1 of the first light-emitting control signal EM1_1 corresponding to the 1st pixel circuit row and the first sub-segment d1 of the first light-emitting control signal EM1_13 corresponding to the 13th pixel circuit row can be aligned in time.

The first light-emitting driving circuit is connected to n first clock signal lines 51, and the active levels of the first clock signals on different first clock signal lines 51 are staggered in time. The timing of the first clock signal affects the timing of the first light-emitting control signal. Specifically, the first clock signal includes S second sub-segments within the one-frame scanning time, and the S second sub-segments correspond one-to-one to the S first sub-segments, and the first clock signal in the second sub-segment includes m/n active pulses, such that the first sub-segment of the first light-emitting control signal corresponding to the 1st pixel circuit row and the first sub-segment of the first light-emitting control signal corresponding to the m+1-th pixel circuit row can be aligned in time.

In some embodiments, as shown in FIG. 16, the signal on the first clock signal terminal CLK is the first clock signal, the first sub-segment d1 includes the second-type sub-segment d12, and the duty cycle of the active level of the first light-emitting control signal EM1 in the second-type sub-segment d12 is 0. The second sub-segment d2 includes a fourth-type sub-segment d24, the fourth-type sub-segment d24 corresponds to the second-type sub-segment d12, and the duty cycle of the active level of the first clock signal in the fourth-type sub-segment d24 is 0. That is, the first clock signal in the fourth-type sub-segment d24 remains at the cut-off level.

The duty cycle of the active level of the first light-emitting control signal EM1 in the second-type sub-segment d12 is 0, which means that the duty cycle of the cut-off level of the first light-emitting control signal EM1 in the second-type sub-segment d12 is 1. The duty cycle of the active level of the first clock signal in the fourth-type sub-segment d24 is 0, which means that the duty cycle of the cut-off level of the first clock signal in the fourth-type sub-segment d24 is 1.

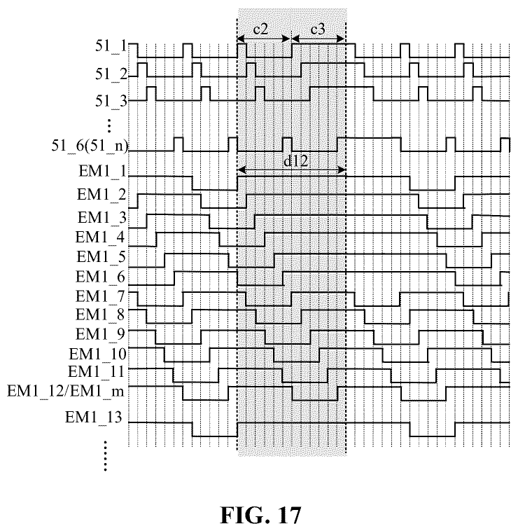

To better explain why the duty cycle of the active level of the first clock signal in the fourth-type sub-segment is set to 0, referring to FIGS. 13 and 17, taking n=6, m=12 as an example. The 1st first shift register to the 6th first shift register VSR1_6 are sequentially connected to the 1st first clock signal line 51_1 to the 6th first clock signal line 51_6, and the 1st first shift register VSR1_1 to the 6th first shift register VSR1_6 sequentially output the first light-emitting control signals EM1_1 to EM1_6. The 7th first shift register VSR1_7 to the 12th first shift register VSR1_12 are sequentially connected to the 1st first clock signal line 51_1 to the 6th first clock signal line 51_6, and the 7th first shift register VSR1_7 to the 12th first shift register VSR1_12 sequentially output the first light-emitting control signals EM1_7 to EM1_12.

The timing of the first clock signal on the 1st first clock signal line 51_1 determines the timing of the first light-emitting control signals EM1_1 and EM1_7. If the first clock signal on the 1st first clock signal line 51_1 is changed to the cut-off level (high level) only in the period c3, the active pulse of the first clock signal on the 1st first clock signal line 51_1 in the period c2 is still retained, which makes the first light-emitting control signal EM1_1 maintain the cut-off level in its second-type sub-segment d12, but the first light-emitting control signal EM1_7 cannot have a second-type sub-segment with a cut-off level duty cycle of 1.

Specifically, if the first clock signal on the 1st first clock signal line 51_1 is changed to the cut-off level (high level) only in the period c3, the active pulse of the first clock signal on the 1st first clock signal line 51_1 in the period c2 is still retained, the first light-emitting control signal EM1_1 to the first light-emitting control signal EM1_6 have the second-type sub-segment with the cut-off level duty cycle of 1, and the first light-emitting control signal EM1_7 to the first light-emitting control signal EM1_12 cannot have the second-type sub-segment with the cut-off level duty cycle of 1.The first light-emitting control signal EM1_13 to the first light-emitting control signal EM1_18 have the second-type sub-segment with the cut-off level duty cycle of 1, and the first light-emitting control signal EM1_19 to the first light-emitting control signal EM1_24 cannot have the second-type sub-segment with the cut-off level duty cycle of 1; and so on.

In the present embodiment, setting the duty cycle of the active level of the first clock signal in the fourth-type sub-segment to 0 enables the duty cycle of the active level of the first light-emitting control signal in the second-type sub-segment to be 0 as well.

It should be noted that the drawings of the present application illustrates by way of example, that the duration of one active level of the first light-emitting control signal EM1 is equal to the duration of one active level of the first clock signal on the first clock signal line 51, which is not intended to limit the present application. In other examples, the two may not be equal.

In some embodiments, as shown in FIG. 13, the first light-emitting driving circuit 31 includes a plurality of cascaded first shift registers VSR1, and the trigger signal terminal STV of the first-stage first shift register VSR1_1 is connected to the trigger signal line 52. The other end of the trigger signal line 52 is connected to a driver chip, and the driver chip provides a trigger signal to the trigger signal terminal STV of the first-stage first shift register VSR1_1.

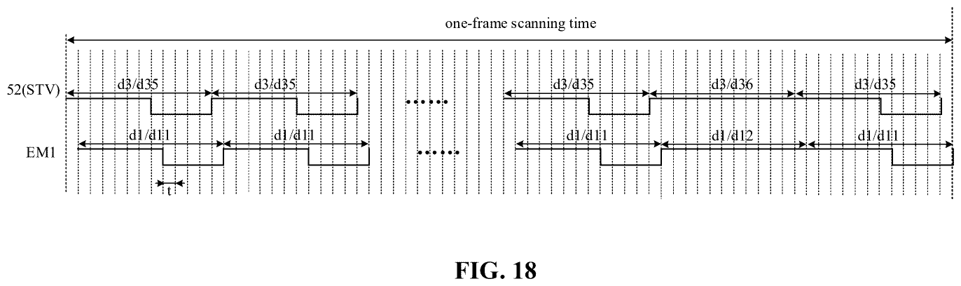

As shown in FIG. 18, within the one-frame scanning time of the display panel, the trigger signal on the trigger signal line 52 includes S third sub-segments d3, and the S third sub-segments d3 correspond one-to-one to the S first sub-segments d1.

The trigger signal on the trigger signal line 52 is typically a periodic signal. One third sub-segment can be understood as one cycle of the trigger signal. Within the one-frame scanning time, it is equivalent to dividing the trigger signal into S cycles on average, and dividing the first light-emitting control signal into S cycles on average. The cycle of the trigger signal corresponds one-to-one to the cycle of the first light-emitting control signal.

Referring to FIGS. 14 and 15. The trigger signal is configured to trigger the first shift register to start working. The timing of the first light-emitting control signal output from the first shift register follows the timing of the trigger signal. In the present embodiment, the S third sub-segments of the trigger signal correspond one-to-one to the S first sub-segments of the first light-emitting control signal, which can avoid timing conflicts.

It can be understood that, as shown in FIG. 15, within the one-frame scanning time, the waveform of the first light-emitting control signal EM1 is shifted backward relative to the waveform of the trigger signal on the trigger signal terminal STV by a shift duration, for example, a shift duration t.

In some embodiments, as shown in FIG. 18, the first sub-segment d1 includes the first-type sub-segment d11, and the duty cycle of the active level of the first light-emitting control signal EM1 in the first-type sub-segment d11 is a, where 0<a<0.5. The third sub-segment d3 includes a fifth-type sub-segment d35, the fifth-type sub-segment d35 corresponds to the first-type sub-segment d11, and the number of active pulses of the trigger signal on the trigger signal line 52 in the fifth-type sub-segment d 35 is equal to the number of active pulses of the first light-emitting control signal EM1 in the first-type sub-segment d11.

In the first-type sub-segment d11 and the fifth-type sub-segment d35 corresponding to each other, the first-type sub-segment d11 is shifted backward relative to the fifth-type sub-segment d35, for example, by a shift duration t.

The timing of the first light-emitting control signal follows the timing of the trigger signal. In the present embodiment, the number of active pulses of the first light-emitting control signal in the first-type sub-segment and the number of active pulses of the trigger signal in the fifth-type sub-segment are set to be the same, which can avoid timing conflicts.

In some embodiments, as shown in FIG. 18, the first sub-segment d1 includes the second-type sub-segment d12, and the duty cycle of the active level of the first light-emitting control signal EM1 in the second-type sub-segment d12 is 0. The third sub-segment d3 includes a sixth-type sub-segment d36, the sixth-type sub-segment d36 corresponds to the second-type sub-segment d12, and the duty cycle of the active level of the trigger signal on the trigger signal line 52 in the sixth-type sub-segment d36 is 0. The duty cycle of the active level of the first light-emitting control signal EM1 in the second-type sub-segment d12 is 0, which means that the duty cycle of the cut-off level of the first light-emitting control signal EM1 in the second-type sub-segment d12 is 1. The duty cycle of the active level of the trigger signal on the trigger signal line 52 in the sixth-type sub-segment d36 is 0, which means that the duty cycle of the cut-off level of the trigger signal on the trigger signal line 52 in the sixth-type sub-segment d36 is 1.

In the second-type sub-segment d12 and the sixth-type sub-segment d36 corresponding to each other, the second-type sub-segment d12 is shifted backward relative to the sixth-type sub-segment d36, for example, by the shift duration t.

The timing of the first light-emitting control signal follows the timing of the trigger signal. In the present embodiment, the trigger signal in the fifth-type sub-segment is set to maintain the cut-off level, so that the first light-emitting control signal in the second-type sub-segment can be maintained at the cut-off level.

It should be noted that the drawings of the present application exemplarily show that the duration of one active level of the first light-emitting control signal EM1 is equal to the duration of one active level of the trigger signal on the trigger signal line 52, which is not intended to limit the present application. In other examples, the two may not be equal.

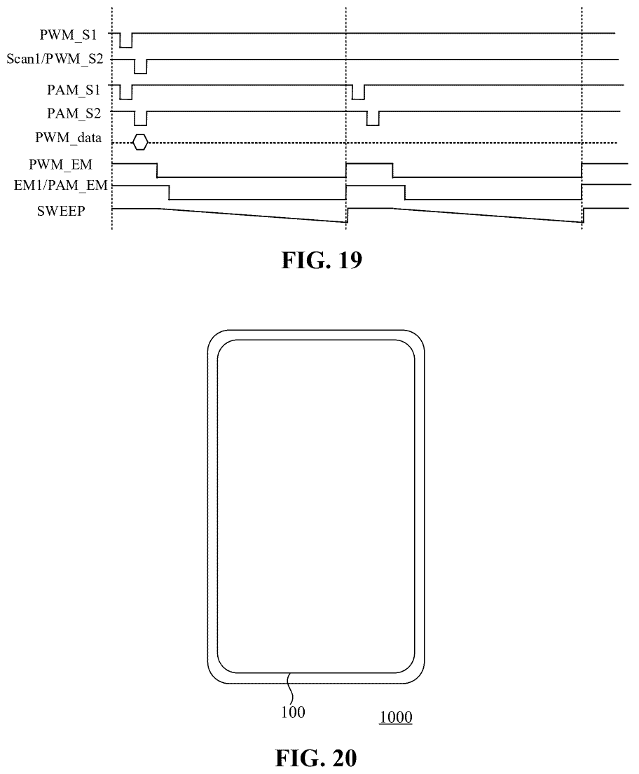

Exemplarily, as shown in FIG. 4, the pixel circuit includes a PAM module and a PWM module, the first scanning driving circuit is electrically connected to the PWM module, and the first light-emitting driving circuit is connected to the PAM module. As shown in FIG. 19, within the one-frame scanning time, the first light-emitting control signal EM1 (PAM_EM) includes a plurality of first sub-segments d1, and in each first sub-segment d1, the scanning signal PAM_S2 includes an active level (e.g., a low level), and the data voltage PAM_data can be written into the driving transistor T11 of the PAM in each first sub-segment d1, i.e., the data voltage PAM_data can be written a plurality of times within the one-frame scanning time.

The first scanning driving signal Scan1 (i.e., PWM_S2) includes only one low level within the one-frame scanning time, and thus the data voltage PWM_data is written into the driving transistor T21 of the PWM module once within the one-frame scanning time.

It should be noted that the present application exemplifies the active level of each signal as a low level and the cut-off level as a high level, which is not intended to limit the present application. Those skilled in the art can make appropriate changes to the embodiments of the present application according to requirement, such as changing the active level to a high level, changing the cut-off level to a low level, etc.

The present application also provides a display apparatus, including a display panel according to the present application. Referring to FIG. 20, FIG. 20 is a schematic structural diagram of the display apparatus according to the embodiment of the present application. The display apparatus 1000 provided in FIG. 20 includes a display panel 100 according to any one of the aforementioned embodiments of the present application. One embodiment of FIG. 20 only takes a mobile phone as an example to illustrate the display apparatus 1000. It can be understood that the display apparatus according to the embodiment of the present application may be a wearable product, a computer, a television, a car display apparatus and other display apparatus with a display function, which is not specifically limited herein. The display apparatus according to the embodiments of the present application has the beneficial effects of the display panel according to the embodiments of the present application. For details, reference may be made to a specific description of the display panel in the aforementioned embodiments, which is not be repeated here in the present embodiment.

According to the aforementioned embodiments of the present application, the embodiments do not describe all the details in detail, nor do the embodiments limit the present application to only the specific embodiments described, apparently, many modifications and changes can be made based on the above description. The present specification selects and specifically describes the embodiments to better explain principles and practical applications of the present application, so that those skilled in the art can make good use of the present application and make modifications based on the present application. The present application is only limited by the claims and the full scope and equivalents of the claims.

What is claimed is:

1. A display panel, comprising:
a pixel circuit, a plurality of the pixel circuits being arranged in a first direction to form a pixel circuit row, the R pixel circuit rows being arranged in a second direction, the first direction intersecting with the second direction;
a first scanning driving circuit, the first scanning driving circuit providing a first scanning driving signal for the pixel circuit row, a duration of the first scanning driving circuit scanning a row of the pixel circuits being t; and
a first light-emitting driving circuit, the first light-emitting driving circuit providing a first light-emitting control signal comprising S first sub-segments for the pixel circuit row, a duration of the first sub-segment being m*t, where m is a positive integer;
wherein the pixel circuit comprises a first data writing transistor, a first electrode of the first data writing transistor is electrically connected to a data line, and a control terminal of the first data writing transistor is electrically connected to a first scanning driving line, the first scanning driving circuit is electrically connected to the first scanning driving line,
wherein an one-frame scanning time T of the display panel comprises a display scanning period and a front-and-back porch period, a duration of the display scanning period is M, and a duration of the front-and-back porch period is N, where M=R*t, N=P*t, T=M+N,
wherein S=(R+P)/m, S is a positive integer, and R/m is a positive integer.

2. The display panel according to claim 1, wherein the first sub-segment comprises a first-type sub-segment, and a duty cycle of an active level of the first light-emitting control signal in the first-type sub-segment is greater than 0; and the duty cycles of the active levels of the first light-emitting control signals in the different first-type sub-segments are same.

3. The display panel according to claim 1, wherein the first sub-segment comprises a first-type sub-segment, and a duty cycle of an active level of the first light-emitting control signal in the first-type sub-segment is a, where 0<a<0.5; and within the one-frame scanning time of the display panel, a number of the first-type sub-segments is S1, where S1=S.

4. The display panel according to claim 1, wherein the first sub-segment comprises a first-type sub-segment and a second-type sub-segment; a duty cycle of an active level of the first light-emitting control signal in the first-type sub-segment is a, and a duty cycle of an active level of the first light-emitting control signal in the second-type sub-segment is b, where 0≤b<a<0.5;
within the one-frame scanning time of the display panel, a number of the first-type sub-segments is S1, and a number of the second-type sub-segments is S2, where S=S1+S2.

5. The display panel according to claim 4, wherein b=0.

6. The display panel according to claim 5, wherein S1>S2.

7. The display panel according to claim 5, wherein at least one of the second-type sub-segments is located within the front-and-back porch period.

8. The display panel according to claim 5, wherein in the same one-frame scanning time of the display panel, the second-type sub-segments in the first light-emitting control signals corresponding respectively to the R pixel circuit rows are within a target period, and a duration of the target period is less than M.

9. The display panel according to claim 8, wherein M>N, and the duration of the target period is less than N.

10. The display panel according to claim 7, wherein the second-type sub-segment in the first light-emitting control signal corresponding to the j-th pixel circuit row is located within the front-and-back porch period, where 1≤j≤R.

11. The display panel according to claim 5, wherein the h pixel circuit rows are arranged in the second direction to form a pixel circuit group, and the R pixel circuit rows comprise a plurality of the pixel circuit groups;
within the same one-frame scanning time of the display panel, relative positions of the second-type sub-segments in the first light-emitting control signals corresponding respectively to the different pixel circuit rows in the same pixel circuit group are same, and the relative position of the second-type sub-segment in the first light-emitting control signal corresponding to the j-th pixel circuit row is different from the relative position of the second-type sub-segment in the first light-emitting control signal corresponding to the j+h-th pixel circuit row; and the relative position is a target number of the first-type sub-segments between an active level of the first scanning driving signal and the second-type sub-segment in the first light-emitting control signal corresponding to the pixel circuit row.

12. The display panel according to claim 11, wherein within the same one-frame scanning time of the display panel, the active level of the first scanning driving signal corresponding to the j-th pixel circuit row is before the active level of the first scanning driving signal corresponding to the j+h-th pixel circuit row,
the target number corresponding to the j-th pixel circuit row is j1, and the target number corresponding to the j+h-th pixel circuit row is j2, where j1=j2+h.

13. The display panel according to claim 5, wherein within the same one-frame scanning time of the display panel, the numbers of the second-type sub-segments in the first light-emitting control signals corresponding respectively to the different pixel circuit rows are same.

14. The display panel according to claim 13, wherein within the same one-frame scanning time of the display panel, the relative position of the k-th second-type sub-segment in the first light-emitting control signal corresponding to the j3-th pixel circuit row is the same as the relative position of the k-th second-type sub-segment in the first light-emitting control signal corresponding to the j4-th pixel circuit row, where 1≤j3<j4≤R; and
the relative position is a target number of the first-type sub-segments between an active level of the first scanning driving signal and the second-type sub-segment in the first light-emitting control signal corresponding to the pixel circuit row.

15. The display panel according to claim 5, wherein S2≥2, and the two adjacent second-type sub-segments in the first light-emitting control signal corresponding to the pixel circuit row are spaced by the q first-type sub-segments.

16. The display panel according to claim 1, wherein the first light-emitting driving circuit comprises a plurality of cascaded first shift registers, the first shift register comprises a first output transistor, a first electrode of the first output transistor is connected to a first clock input terminal, and a second electrode of the first output transistor is connected to an output terminal of the first shift register, the output terminal of the first shift register outputs the first light-emitting control signal;
the first clock input terminal is electrically connected to a first clock signal line, and a number of the first clock signal lines electrically connected to the first light-emitting driving circuit is n, where n is an integer, R/n is an integer, and m/n is an integer;
a duration of an active level of the first light-emitting control signal in the first sub-segment is less than or equal to t*n.

17. The display panel according to claim 16, wherein a duration of the active level of the first light-emitting control signal in the first sub-segment is equal to t*n.

18. The display panel according to claim 17, wherein within the same one-frame scanning time of the display panel, a first clock signal on the first clock signal line comprises S second sub-segments, and the S second sub-segments correspond to the S first sub-segments.

19. The display panel according to claim 1, wherein the pixel circuit comprises a pulse amplitude modulation module and a pulse width modulation module, the pulse width modulation module is electrically connected to the pulse amplitude modulation module, and the pulse amplitude modulation module is electrically connected to a light-emitting element;
the first scanning driving circuit is electrically connected to the pulse width modulation module;
the first light-emitting driving circuit is electrically connected to the pulse amplitude modulation module.

20. A display apparatus comprising a display panel comprising:
R pixel circuit rows being arranged in a second direction, a plurality of pixel circuits being arranged in a first direction to form the pixel circuit row, the first direction intersecting with the second direction;
a first scanning driving circuit, the first scanning driving circuit providing a first scanning driving signal for the pixel circuit row, a duration of the first scanning driving circuit scanning a row of the pixel circuits being t; and
a first light-emitting driving circuit, the first light-emitting driving circuit providing a first light-emitting control signal comprising S first sub-segments for the pixel circuit row, a duration of the first sub-segment being m*t, where m is a positive integer;
wherein the pixel circuit comprises a first data writing transistor, a first electrode of the first data writing transistor is electrically connected to a data line, and a control terminal of the first data writing transistor is electrically connected to a first scanning driving line, the first scanning driving circuit is electrically connected to the first scanning driving line,
wherein an one-frame scanning time T of the display panel comprises a display scanning period and a front-and-back porch period, a duration of the display scanning period is M, and a duration of the front-and-back porch period is N, where M=R*t, N=P*t, T=M+N,
wherein S=(R+P)/m, S is a positive integer, and R/m is a positive integer.
